(19) United States
(12) Patent Application Publication
(10) Pub. No.: US 2011/0070048 A1
(43) Pub. Date: Mar. 24, 2011

(54) CRIMPED CABLE BOLT HEAD AND ASSEMBLY

(76) Inventor: Roy Lee Robertson, JR., Delbarton, WV (US)

(21) Appl. No.: 12/890,467

(22) Filed: Sep. 24, 2010

Related U.S. Application Data
(60) Provisional application No. 61/245,355, filed on Sep. 24, 2009.

(51) Int. Cl. F16B 19/00; B23P 11/00

(52) U.S. Cl. 411/354; 411/360; 29/505

(57) ABSTRACT

A mine roof cable bolt head has a drive head, a reinforcing collar and a crimp tube. The drive head is located at one end of the cable bolt head while the crimp tube is at the other end. The reinforcing collar is located between the two ends of the cable bolt head, adjoining the drive head. A hollow shaft passes through the length of the cable bolt head from end to end. A cable can be joined to the cable bolt head by using wedges. Once the cable is joined to the cable bolt head, the crimp tube is crimped down onto the cable to provide resistance to twist and to share some of the tensile load with the wedge joint. The reinforcing collar provides additional strength in the area of the wedge joint. The cable bolt head may be made of more than one pieces.

### CROSS REFERENCE TO RELATED APPLICATIONS

This application claims priority from U.S. Provisional Application 61/245,355, filed on Sep. 24, 2009, and the teachings in the specification and accompanying submissions for U.S. Provisional Application 61/245,355, are incorporated herein by reference.

### FIELD OF THE INVENTION

The several embodiments of the current invention relate to cable mine roof bolts. In particular, the embodiment of the current invention relates to more strongly affixing the head of a cable mine roof bolt to the cable.

### BACKGROUND OF THE INVENTION

Underground mine shafts sometimes experience cave-ins, collapses, or falling rock. Over time, the roofs of underground mine shafts can deteriorate due to the layered and stratified makeup of the earth. With the deterioration, these layers can separate and those at the surface of the mine roof may pull away and collapse into the mine shaft. To maintain the integrity of the ceiling, it is a common practice to drill holes up into the ceiling through several layers of rock until a known stable layer is encountered. Once the hole is drilled, a support, such as a mine roof bolt or cable, may be inserted up into the hole and fixed into place. The other end of the support extends slightly out of the hole and a bolt head on the anchor supports a plate up against the surface of the mine roof.

Frequently, the holes drilled up into the mine roof are slightly over-sized for the anchor being used and frangible pouches containing different constituencies of a multi-constituent adhesive are inserted up into the hole. The support has a bolt head for engagement by a wrench or driver and the support is spun in the hole to tear the pouches and mix the different constituents of the adhesive until it hardens. This adhesive then bonds with the sides of the hole in the mine roof and maintains the mine roof support in position. If the support is merely a straight bolt or a section of cable, then the adhesive alone fixes the support in place. Some mine roof supports combine a mechanically expanding anchor with the adhesive to provide additional anchoring. These mechanically expanding supports may be used in conjunction with either straight bolts or cable bolts.

When straight bolts are used as mine roof supports, it is relatively easy to form them from standard rebar and stamp bolt heads onto the end of the bolt. However, when cables are used, a bolt head must be fastened to the section of cable in order for a wrench or other driver to be able to turn the cable, either for mixing adhesive, or driving a mechanically expanding anchor. A common method for the attachment of a bolt head to a cable uses wedges between the cable and a hollow shaft through the bolt head. A bolt head having a hollow shaft through it has a cable inserted through the hollow shaft. The bolt head is positioned near the end of the cable and the wedges are inserted at an initial position at the opening of the bolt head near the end of the cable and between the cable and the hollow shaft within the bolt head. The cable then is pulled back into the bolt head causing the wedges to be drawn in with the cable and creating a wedging effect between the cable, the wedges, and the bolt head.

While this technique does provide a way of fixing the bolt head to the cable, when the cable is actually used, the connection between the bolt head and the cable may weaken and the bolt head may come loose. This can happen, in particular, when the cable is driven and turned to mix the adhesive, or to drive a mechanical expansion anchor. The torque of turning the cable creates forces within the joint between the bolt head and the cable that are not in the direction that is used to form the joint. In this rotational direction, the joint is less strong and will sometimes loosen. Also, the turning of the bolt head may deform the cable which is comprised of a large number of strands intertwined.

Additionally, some joints formed in this way between the cable and the bolt head can be overcome by the forces of supporting the mine roof ceiling. Once the cable bolt is in place and supporting a plate which in turn supports the ceiling, the ceiling may yield or sag. As the ceiling yields and weight is transferred to the plate supported by the cable bolt, the bolt head of the cable comes under extreme forces. In some cases, the material from which the bolt head is made can yield and the bolt head will deform allowing the bolt head to slip off the cable around the wedges.

For the reasons stated above, it is necessary to make improvements upon prior cable roof bolts, their bolt heads, and the manner in which they are joined. Embodiments of the current invention address the shortcomings of the prior art. These and other improvements will be described below.

### DESCRIPTION OF RELEVANT ART

U.S. Pat. No. 5,253,960 by Scott is for a “Cable Attachable Device to Monitor Roof Loads or Provide a Yieldable Support or a Rigid Roof Support Fixture”. The invention of Scott comprises a cable attachment assembly having an anchor mechanism for gripping a tension member anchored in a bore hole in a mine roof, and a roof plate mounted on the anchor mechanism in position for observing the support being offered to the mine roof, or the yielding response of the roof plate on the anchor mechanism, or for monitoring the load-yield relationship of the anchor mechanism relative to the tension member.

U.S. Pat. No. 5,511,909, by Calandra, Jr. et al, is for a “Cable bolt and method of use in supporting a rock formation.” In this patent, a flexible multi-strand steel cable of a preselected length is inserted in a bore hole drilled in a rock formation above an underground excavation. The cable includes an anchor end portion positioned in the bore hole for frictionally engaging the cable to the wall of the bore hole. The anchor end portion may also be chemically bonded to the surrounding rock formation. The cable extends out of the bore hole and includes a drive end portion that retains a bearing plate opposite the opening into the bore hole. The drive end portion includes a pair of diametrically positioned jaw members on the cable. The jaw members form a frustoconical outer surface positioned within a tapered bore of a collar. The collar advances on the jaw members to compress them into nonrotational gripping engagement with the steel cable. End portions of the jaw members extend out of the collar on the cable. A torque transmitting device engages the ends of the jaw members removed from contact with the collar to transmit upward thrust and rotation through the jaw members to the cable and place the anchored cable in tension to reinforce the overlying strata of the rock formation.

U.S. Pat. No. 5,230,589 by Gillespie is for a “Mine roof bolt”. In this patent, an improved mine roof bolt is constructed of pre-tensioned, multi-strand steel cable. The bolt head is constructed of a hexagonal- or other drive-headed collar having an internally tapered frusto-conical bore therethrough, and a tapered plug having a frusto-conical outer surface that engages the frusto-conical inner surface of the drive collar. The tapered plug has an internal bore essentially concentric with the outer frusto-conical surface, and is adapted to fit over the multi-stranded steel cable, the hexagonal head drive collar fitting over the tapered plug such that pressing the tapered plug and steel cable into the inner frustoconical bore of the hexagonal-head drive collar causes serrations on the internal bore of the tapered plug to be urged down against, and bite into, the steel cable, resulting in a solid hexagonal head for the cable bolt. The tapered plug is in actuality, a pair of essentially identical diametrically opposed semi-frusto-conical tapered sections that more easily compress together to bite into the multi-strand steel cable. The improved mine roof bolt is intended for use in passive-type mine roof systems.

### SUMMARY

Embodiments of the cable bolt head of the current invention have several features to address shortcoming of the prior art. The cable bolt head is comprised of several components stacked on top of each other. The first component is a square drive head sized and adapted to fit in common wrenches or drivers used for mine roof bolts. Stacked onto, or adjoined to, this drive head is a reinforcing collar which has a large radius and additional thickness as compared to similar sections in prior art cable bolt heads. Next the cable bolt head has a crimping collar section which is not as large in diameter as the reinforcing collar but may have greater height than the reinforcing collar. In addition to the body of the cable bolt head, there are wedges which may be semi-circular in shape which fit between the cable and the cable bolt head to create a wedging effect. Once the cable is wedged into position within the cable bolt head using the wedges, a crimp is made in the crimping tube to squeeze the crimping tube down on to the cable and provide an additional stronger attachment between the cable bolt and the cable bolt head at the crimp.

The reinforcing collar segment of the cable bolt head is more important once the unit is installed. As the cable bolt head comes under load, the reinforcing collar provides additional material strength to the cable bolt head to prevent yielding of the material which would allow the cable and wedges to pull through the cable bolt head. Additionally, the forces on the upper surface of the reinforcing collar are distributed across its larger area.

As discussed above, the article and method of the present invention overcomes the disadvantages inherent in prior art methods and prior art devices. In this respect, before explaining at least one embodiment of the invention in detail, it is to be understood that the invention is not limited in its application to the details of construction and/or to the arrangement of the support structure set forth in the following description or illustrated in the drawings. The invention is capable of other embodiments and of being practiced and carried out in various and diverse ways. Also, it is to be understood that the phraseology and terminology employed herein are for the purposes of description and should not be regarded as limiting.

Accordingly, those skilled in the art will appreciate that the concept upon which this invention is based may readily be utilized as a basis for the design of other structures, methods, and systems for carrying out the purposes of the present invention. It is important, therefore, that the claims be regarded as including such equivalent constructions insofar as they do not depart from the spirit and scope of the present invention.

Furthermore, the purpose of the foregoing Abstract is to enable the U.S. Patent and Trademark Office and the public generally, and especially including the practitioners of the art who are not familiar with patent or legal terms or phraseology, to determine quickly from a cursory inspection, the nature and essence of the technical disclosure of the application. The Abstract is neither intended to define the invention of this application, nor is it intended to be limiting to the scope of the invention in any respect.

### BRIEF DESCRIPTION OF THE DRAWINGS

Additional utility and features of this invention will become more fully apparent to those skilled in the art by reference to the following drawings, wherein all components are designated by like numerals and described more specifically.

FIG. 1 is a cross-sectional side view of an embodiment of the cable bolt head and wedges assembled onto a cable bolt.

FIG. 2 is a side view of the assembly of FIG. 1.

FIG. 3 is a cross-sectional side view of the cable bolt head embodiment shown in FIG. 1 with wedges separated and prior to assembly onto a cable.

FIG. 4 is a side view of the cable bolt head of FIG. 3.

FIG. 5 is a top view of the cable roof bolt head.

FIG. 6 is a bottom view of cable roof bolt head.

FIG. 7 is a top view of semi-circular wedges which may be used to assemble the cable into a cable roof bolt head.

FIG. 8 is a cross-sectional side view of an embodiment of a cable bolt head with a separate reinforcing collar shown above an assembled cable bolt head and the wedges separated.

FIG. 9 is a side view of the cable bolt head of FIG. 8.

### DETAILED DESCRIPTION OF EMBODIMENTS

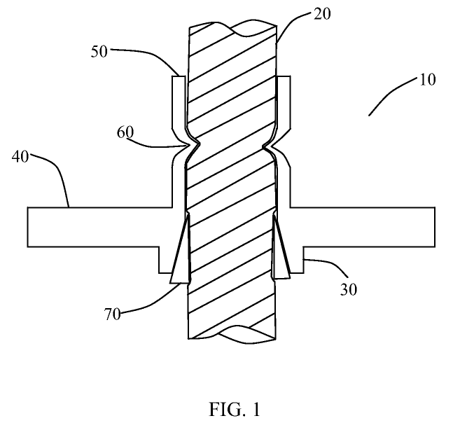

Referring to FIG. 1, a cross-section of the cable bolt head 10, wedges 70, and cable 20 are shown. Cable bolt head 10 has a hollow shaft extending from top to bottom sized to receive cable 20. At the bottom of cable bolt head 10 is drive head 30. Above the drive head 30 is reinforcing collar 40 which, in the embodiment shown, has a larger radius than the rest of cable bolt head 10 and provides substantial reinforcement in the area where wedges 70 and cable 20 are squeezed into the hollow center of cable bolt head 10. Above reinforcing collar 40, crimping tube 50 extends. Crimping tube 50 has a thinner wall than reinforcing collar 40 and drive head 30 and, in the embodiment shown, is taller than those elements.

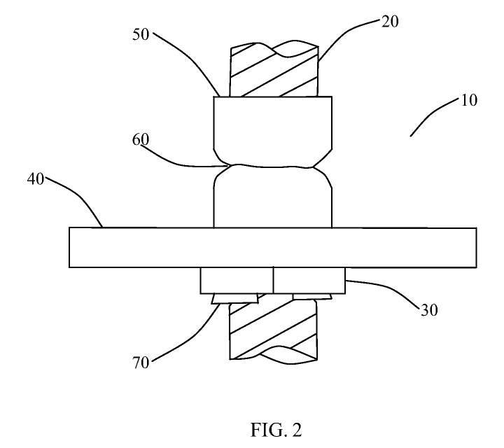

To assemble cable 20, cable bolt head 10, and wedges 70, cable 20 is inserted through the hollow inside of cable bolt head 10, and wedges 70 are positioned alongside cable 20 at the opening at the drive head end of cable bolt head 10. Then cable 20 is pulled back through cable bolt head 10 until cable 20 and wedges 70 lock into the interior of cable bolt head 10. Cable 20, wedges 70, and cable bolt head 10 are locked together through a wedging effect. Once cable bolt head 10 is attached to cable 20, a crimp 60 is created in crimp tube 50 to squeeze crimp tube 50 down onto cable 20. This provides a more resilient connection between cable 20 and cable bolt head 10. The connection at crimp 60 is more resilient against twisting motion when cable bolt 20 is installed in a mine roof bolt hole and turned through engagement of drive head 30. In prior art applications, it is not unusual for a connection at the wedges to loosen with the spinning motion applied to the cable bolt assembly. The spinning creates a twist between the cable and the cable bolt head which can loosen the wedge joint between the cable and bolt head, particularly, if the strands of the cable lose cohesion and yield around the wedges. In addition to preventing twist from being transmitted to the wedge joint, the connection at crimp 60 takes some of the tensile load induced in the cable. Referring now to FIG. 2, a side view of a cable bolt head and cable is shown. As may be seen in FIG. 2, FIG. 4, and FIG. 6, drive head 30 has flat sides 35 for engaging a driver, in this case a square driver. Crimp 60 in FIG. 2 circumscribes crimp tube 50. In some embodiments, crimp 60 may be several discrete crimps located around the circumference of crimp tube 50. In FIG. 2, wedges 70 may be seen partially wrapping around the outer diameter of cable 20. In some embodiments, wedges 70 will be semi-circular wedges which contact the outer surface of a cable. In other embodiments, a wedge may be inserted into the interior of a cable to expand its exterior surfaces and create the wedging effect.

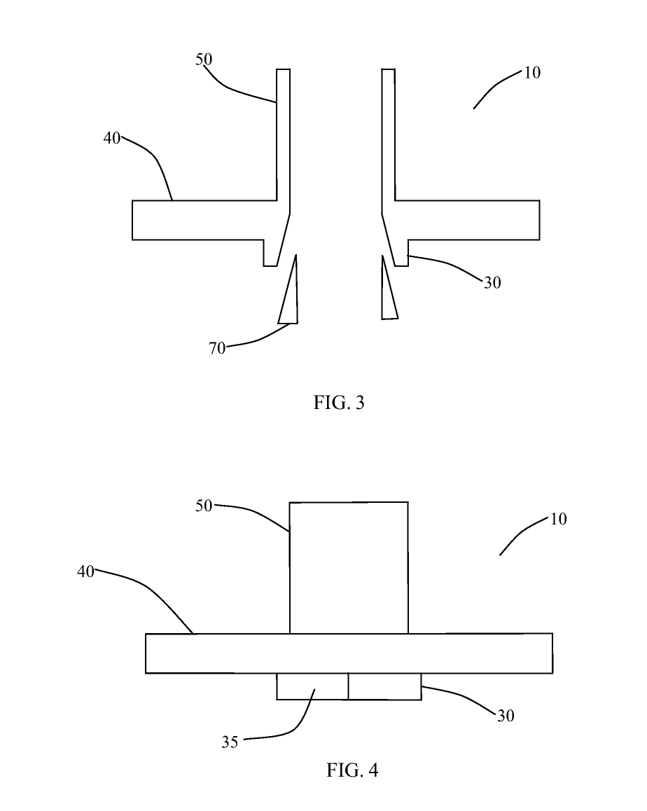

Referring now to FIG. 3, an un-deformed cross section of cable bolt head 10 may be seen. As can be seen here, crimp tube 50 is initially a smooth continuous tube section before the installation and crimping of cable bolt head 10. FIG. 4 is a side view of cable bolt head 10 before assembly on cable 20.

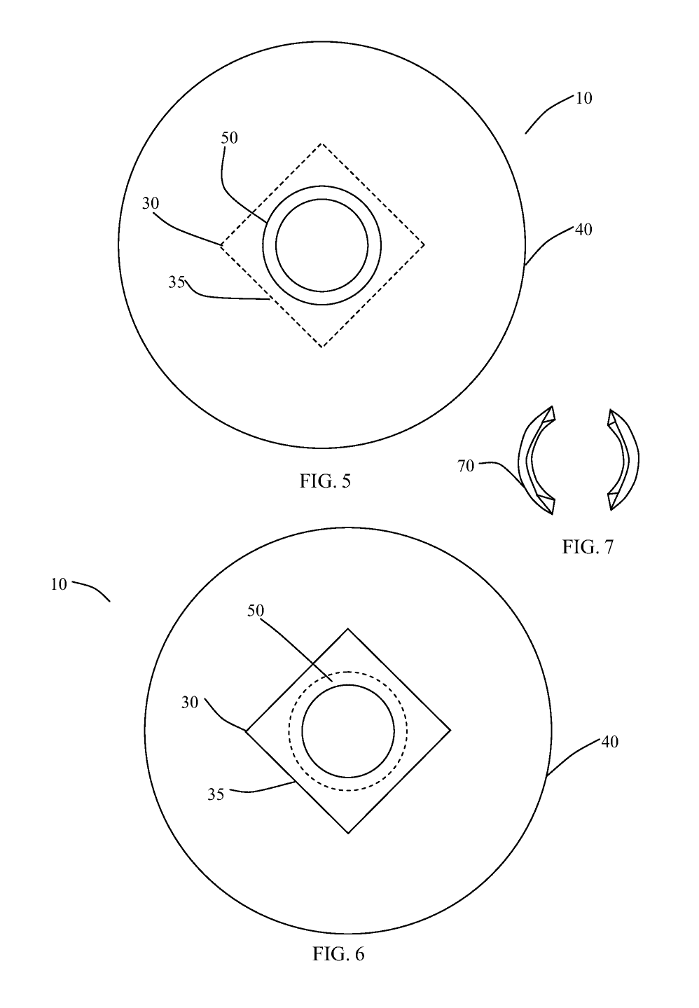

FIG. 5 is a top view of cable bolt head 10 and shows a clear passage through the cable bolt head. FIG. 6 is a bottom view of cable bolt head 10 and shows the shape of drive head 30 for engaging with wrenches or drivers.

FIG. 7 shows an embodiment of the wedges 70. In FIG. 7, wedges 70 have a thicker bottom and thinner top for the wedging effect while also having a semi-circular shape to conform to the cable 20 and the interior of cable bolt head 10. This embodiment of wedges 70 provides a distributed engagement between cable 20, wedges 70, and cable bolt head 10. The wedges can take a variety of shapes and configurations in other embodiments.

Once cable bolt head 10 is assembled with cable 20 using wedges 70, crimp 60 is made in crimp tube 50 to deform crimp tube 50 down onto cable 20. This provides an additional engagement between cable bolt head 10 and cable 20 which isolates, at least partially, the connection at wedges 70 from rotational stresses. In addition to protecting the wedge joint, this crimping joint provides an additional redundant connection between cable bolt head 10 and cable 20 and takes some of the tensile load exerted on cable bolt 20.

Reinforcing collar 40 provides increased strength in cable bolt head 10 in part of the area where the wedge joint is located. When cable bolt head 10 is subjected to high loads bearing down on it from the mine roof, the wedging effect that serves to hold cable bolt head 10 onto cable 20 generates extremely high stresses within cable bolt head 10. Reinforcing collar 40 is located in this area to provide added strength where the stresses from the wedge joint are concentrated.

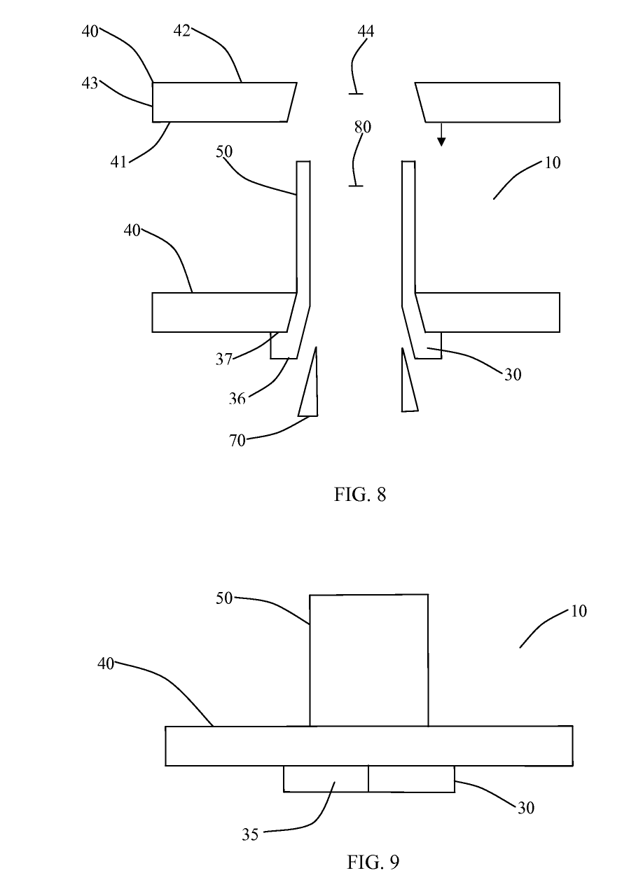

Some embodiments of cable bolt head 10 may have components made separately and then assembled to form cable bolt head 10. FIG. 8 is a cross-sectional side view of an embodiment of a cable bolt head 10 with a separate reinforcing collar 40 shown above an assembled cable bolt head 10 with wedges 70 separated. In FIG. 8, a reinforcing collar 40 is shown assembled into cable bolt head 10 as well as a reinforcing collar 40 being shown positioned ready to be assembled into cable bolt head 10. FIG. 9 is a side view of the cable bolt head of FIG. 8.

In the embodiment of cable bolt head 10 shown in FIG. 8, drive head 30 and crimp tube 50 are formed in a single unit. Drive head 30 has a bottom surface 36 and a top surface 37 and sides 35 (see FIG. 9) joining its top and bottom surfaces, 36 and 37. Sides 35 are arranged and sized to fit a driver that is intended to be used with cable bolt head 10. Crimp tube 50 joins into top surface 37 of drive head 30 and, in the embodiment shown in FIG. 8, crimp tube 50 expands slightly just before joining top surface 37. A hollow shaft 80 runs from an opening at the top of crimp tube 50 down to an opening in bottom surface 36 of drive head 30 Hollow shaft 80 is sized to accommodate the size of cable with which it is intended to be used.

As shown in FIG. 8, reinforcing collar 40 has bottom surface 41, a top surface 42, at least one side 43 joining the two, and an aperture 44 through it from top surface 42 to bottom surface 41. Aperture 44 is sized to fit over crimp tube 50 and, in the embodiment shown in FIG. 8, aperture 44 has a slight taper to its surface to match the expansion of crimp tube 50 near drive head 30. The taper creates a wedging effect when reinforcing collar 40 is pushed down onto crimp tube 50. However, other methods may be employed to achieve retention of reinforcing collar 50 on taper tube 50. For example, aperture 44 and crimp tube 50 could be entirely straight and sized for a light press fit, a threaded joint could be used, a tack weld could be used, or aperture 44 and crimp tube 50 could be sized for a slip fit and allow the expansion produced by assembling cable bolt head 10 onto a cable to retain reinforcing collar 40 on crimp tube 50.

In the embodiments shown in FIGS. 1-9, reinforcing collar 40 is larger across than both drive head 30 and crimp tube 50. In some embodiments, reinforcing collar 40 may actually be the same size or smaller than drive head 30, but not shaped to accommodate a driver. In such an embodiment, reinforcing collar 40 would do little to distribute load, but would still provide reinforcement to crimp tube 50 where reinforcing collar 40 surrounds crimp tube 50 or more generally adds to the circumference of cable bolt head 10 when cable bolt head 10 is of unitary construction.

While several embodiments of a cable bolt head have been discussed above in the specification, it should be born in mind that these are not the only embodiments encompassed by the ensuing claims. Neither should the abstract or drawing figures be considered limiting. Rather the abstract is for overview purposes only and the drawing are to provide ease of understanding example embodiments.

I claim:

1. A cable bolt head comprising:
a drive head at a first end of said cable bolt head, a crimp tube at a second end of said cable bolt head, and a reinforcing collar next to said drive head, said drive head, reinforcing collar, and crimp tube generally coaxially aligned and having a hollow shaft running from said first end of said cable bolt head to said second end of said cable bolt head, said hollow shaft sized to accommodate an intended cable;
said drive head having a bottom surface at said first end of said cable bolt head and sides around the perimeter of said bottom surface, said sides of said drive head being of number, size, and arrangement to accommodate an intended driver;
said reinforcing collar having a top surface, a bottom surface, and at least one side joining said top and bottom surfaces of said reinforcing collar, said bottom surface of said reinforcing collar adjoining said sides of said drive head opposite said bottom surface of said drive head;
said crimp tube having a top end surface at said second end of said cable bolt head with at least one side joined to said top end surface.

2. The cable bolt head of claim 1, further comprising:
at least one wedge sized to fit within said hollow shaft.

3. The cable bolt head of claim 2, wherein:
said at least one wedge is sized and shaped to wedge between the exterior of a cable and the interior of said hollow shaft when said cable bolt head is assembled to a cable.

4. The cable bolt head of claim 1, wherein:
proximal to its end at said bottom surface of said drive head, said hollow shaft expands from its nominal cross section to a larger cross section at said bottom surface of said drive head.

5. The cable bolt head of claim 1, wherein:
said reinforcing collar is larger across than said drive head.

6. The cable bolt head of claim 1, wherein:
said drive head, reinforcing collar, and crimp tube are of unitary construction.

7. The cable bolt head of claim 1, wherein:
said at least one side of said crimp tube is joined to said drive head opposite said bottom surface of said drive head, and;
said reinforcing collar has an aperture from said top surface of said reinforcing collar to said bottom surface of said reinforcing collar, said aperture in said reinforcing collar sized and shaped to fit said at least one side of said crimp tube.

8. A cable bolt head comprising;
a drive head having a top surface, a bottom surface, and sides joining said top and bottom surfaces, said sides of said drive head being of number, size, and arrangement to accommodate an intended driver, and;
a crimp tube having a top end surface and at least one side joined to said top end surface, said at least one side of said crimp tube also being joined to said top surface of said drive head, said drive head being larger across than said crimp tube, wherein;
a hollow shaft extends through said cable bolt head from said top end surface of said crimp tube to said bottom surface of said drive head, said hollow shaft sized to accommodate an intended cable.

9. The cable bolt head of claim 8, further comprising;
a reinforcing collar having a top surface, a bottom surface, and at least one side joining said top and said bottom surfaces, said reinforcing collar further having an aperture from said top surface to said bottom surface, said reinforcing collar being larger across than said crimp tube and said aperture sized to fit around said crimp.

10. The cable bolt head of claim 8, further comprising;
at least one wedge sized to fit in said hollow shaft.

11. The cable bolt head of claim 10, wherein:
said at least one wedge is sized and shaped to wedge between the exterior of a cable and the interior of said hollow shaft when said cable bolt head is assembled to a cable.

12. The cable bolt head of claim 8, wherein:
proximal to its end at said bottom surface of said drive head, said hollow shaft expands from its nominal cross section to a larger cross section at said bottom surface of said drive head.

13. A method of assembling a cable bolt head to a cable, comprising;
passing the end of said cable through a hollow shaft in said cable bolt head, said cable bolt head having a drive head at a first end and a crimp tube at a second end, said drive head being larger across than said crimp tube, said hollow shaft passing from said first end of said cable bolt head to said second end of said cable bolt head and said end of said cable protruding from said drive head;
positioning at least one wedge in proximity to said cable and said drive end;
partially drawing said end of said cable end back toward said drive head until said cable, and said at least one wedge, become wedged in said hollow shaft of said cable bolt head, and;
crimping said crimp tube down onto said cable.

14. A method of assembling a cable bolt head to a cable of claim 13, further comprising;
prior to passing the end of said cable through said hollow shaft in said cable bolt head, sliding a reinforcing collar down over said crimp tube until said reinforcing collar adjoins said drive head, said reinforcing collar having a top surface, a bottom surface, at least one side joining said top and bottom surfaces, and an aperture from said top surface to said bottom surface, said aperture sized to fit over said crimp tube.
